(19) United States
(12) Patent Application Publication
(10) Pub. No.: US 2017/0358233 A1
(43) Pub. Date: Dec. 14, 2017

(54) TEACHING PLAN OPTIMIZATION

(71) Applicant: International Business Machines Corporation, Armonk, NY (US)

(72) Inventors: Tsz S. Cheng, Grand Prairie, TX (US); Stephanie De La Fuente, Dallas, TX (US); Charlet N. Givens, Dallas, TX (US)

(21) Appl. No.: 15/182,182

(22) Filed: Jun. 14, 2016

(51) Int. Cl. G09B 7/04

(52) U.S. Cl. CPC G09B 7/04

(57) ABSTRACT

A method for teaching plan optimization includes initially loading a teaching plan into memory of a computer and then comparing the loaded teaching plan to a set of existing teaching plans disposed in fixed storage of the computer to identify an alternate teaching plan utilizing a presentation format that differs from a presentation format of the loaded teaching plan. Thereafter, the computer monitors a class response to the loaded teaching plan in order to determine an effectiveness of the loaded teaching plan. Consequently, a portion of the class demonstrating a determined effectiveness of the loaded plan teaching below a threshold value is identified. As such, a proportional sharing of presentation of both the loaded teaching plan and the alternative teaching plan to the class is both computed and displayed based upon the identified portion of the class demonstrating the determined effectiveness of the loaded teaching plan below the threshold value.

### BACKGROUND OF THE INVENTION

### Field of the Invention

The present invention relates to learning management and more particularly to learning content delivery.

### Description of the Related Art

The effectiveness of a teacher largely depends upon the subject matter taught by the teacher and the capacity of the students to comprehend the subject matter. As it is well understood, some teachers can enliven even the most boring material, while others can dull even the most enlivening material. Much of the effectiveness of a teacher stems from the personality and charisma of the teacher, while the effectiveness of a teacher also is due to the knowledge and application of good teaching practices by the teacher. As it is well-understood, good teaching practices range from the setting of goals for a class of students to delivering effective presentations to listening to the questions of the students. However, even the best of teaching practices are defeated by circumstances beyond the control of the teacher including an overly large class size or an unacceptable disparity of comprehension amongst the students of a class.

In respect to the latter circumstance, it is commonly understood that in a classroom, different students are of different learning abilities and of different degrees of base knowledge. For a large classroom environment then, the teacher is forced to juggle different teaching styles at different times within a fixed period of time in order to reach each type of student, even if for but a short period of time. For most teachers, however, juggling different teaching styles at different times within a fixed period of time in order to reach each type of student compounds time required to develop and implement an effective teaching plan resulting in the teacher either having failed to adequately prepared a teaching plan for all students present in a class for lack of time, or having failed to produce an optimal teaching plan for any of the students present in the class also for lack of time.

A teaching plan, also known as a lesson plan, strictly speaking, is a detailed description of the course of instruction, or ‘learning trajectory’ for a lesson. A daily lesson plan is developed by a teacher to guide class learning. Details vary depending upon the preference of the teacher, subject being covered, and the needs of the students. As well, there may be requirements mandated by the school system regarding the plan. Thus, a lesson plan is the teacher's guide for running a particular lesson, and the plan includes the goal as to what the students are intended upon learning, how the goal will be reached according to a particular method or procedure, and a way of measuring how well the goal was reached, for instance by test, worksheet, homework and the like.

Clearly, presentation format of the teaching plan for a particular subject of interest will vary depending upon the type of student. Some students absorb learning content through visual means. Others, by way of auditory means. Others, by way of kinesthetic means. Thus, the presentation format by which the teaching plan is presented to the students may vary depending upon a determined way in which the students are predicted learn. More specifically, the approaches for teaching can be broadly classified into teacher centered and student centered. In a teacher-centered approach, teachers are the main authority figure and students are viewed as “empty vessels” whose primary role is to passively receive information by way of lectures and direct instruction with an end goal of testing and assessment. In contrast, in the student-centered approach, while teachers are an authority figure, teachers and students play an equally active role in the learning process. The teacher's primary role is to coach and facilitate student learning and overall comprehension of material. Student learning is measured through both formal and informal forms of assessment, including group projects, student portfolios, and class participation. Commonly used teaching methods may include class participation, demonstration, recitation, memorization, or any combination of the foregoing.

### BRIEF SUMMARY OF THE INVENTION

Embodiments of the present invention address deficiencies of the art in respect to learning content delivery and provide a novel and non-obvious method, system and computer program product for teaching plan optimization for learning management. In an embodiment of the invention, a method for teaching plan optimization includes initially loading a teaching plan into memory of a computer and then comparing the loaded teaching plan to a set of existing teaching plans disposed in fixed storage of the computer to identify an alternate teaching plan utilizing a presentation format that differs from a presentation format of the loaded teaching plan. Thereafter, the computer monitors a class response to the loaded teaching plan in order to determine an effectiveness of the loaded teaching plan. Consequently, a portion of the class demonstrating a determined effectiveness of the loaded plan teaching below a threshold value is identified. As such, a proportional sharing of presentation of both the loaded teaching plan and the alternative teaching plan to the class is both computed and displayed based upon the identified portion of the class demonstrating the determined effectiveness of the loaded teaching plan below the threshold value.

In one aspect of the embodiment, the monitoring is performed by facial recognition of individual students in the class. In another aspect of the embodiment, the monitoring is performed by gaze tracking of individual students in the class. In yet another aspect of the embodiment, the monitoring is performed by audio recognition of individual students in the class. In even yet another aspect of the embodiment, the monitoring is performed by separately and remotely for each student at a different endpoint computer in a distance learning arrangement.

Finally, in an aspect of the embodiment, the method includes generating a query of different terms pertinent to the loaded teaching plan, submitting the query over a computer communications network to a search engine in order to identify supplemental teaching content, retrieving the identified supplemental teaching content from over the computer communications network and associating the retrieved supplemental teaching content with the loaded teaching plan for delivery to the class.

In another embodiment of the invention, a data processing system is configured for teaching plan optimization. The system includes a computer with memory and at least one processor. The system also includes a teaching plan optimization module executing in the memory of the computer. The module includes program code enabled upon execution in the computer to load a teaching plan into the memory of the computer, compare the loaded teaching plan to a set of existing teaching plans disposed in fixed storage of the computer to identify an alternate teaching plan utilizing a presentation format that differs from a presentation format of the loaded teaching plan, monitor by the computer a class response to the loaded teaching plan in order to determine an effectiveness of the loaded teaching plan, identify a portion of the class demonstrating a determined effectiveness of the loaded plan teaching below a threshold value, and compute and display a proportional sharing of presentation of both the loaded teaching plan and the alternative teaching plan to the class based upon the identified portion of the class demonstrating the determined effectiveness of the loaded teaching plan below the threshold value.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for teaching plan optimization;

FIG. 2 is a schematic illustration of a data processing system configured for teaching plan optimization; and,

FIG. 3 is a flow chart illustrating a process for teaching plan optimization.

### DETAILED DESCRIPTION OF THE INVENTION

Embodiments of the invention provide for teaching plan optimization. In accordance with an embodiment of the invention, a lesson plan for a teacher is loaded into memory and different elements of the lesson plan are compared to elements of one or more different previously stored lesson plans. In response to determining a threshold degree of commonality between one of the different lesson plans of a presentation format that is different than that of the lesson plan for the teacher, the one of the different lesson plans is deemed an alternative lesson plan to the lesson plan for the teacher, albeit in the different presentation format. That is to say, the presentation format of the lesson plan for the teacher in which the lesson plan of the teacher is presented to the students differs from the presentation format of the alternative lesson plan in which the alternative teaching plan is presented to the students.

Thereafter, as the lesson plan for the teacher is presented to students in accordance with the presentation format of the lesson plan for the teacher, the response of each of the students is sensed, for instance through written assessments, or through transducing sensors. Based upon the response of different ones of the students, the alternative lesson plan is then presented, in accordance with the presentation format of the alternative lesson plan, in combination with the lesson plan for the teacher and the response of the students is sensed again. Finally, a blend of both lesson plans is determined based upon the proportion of the students best responding to the lesson plan of the teacher and the proportion of the students best responding to the alternative lesson plan.

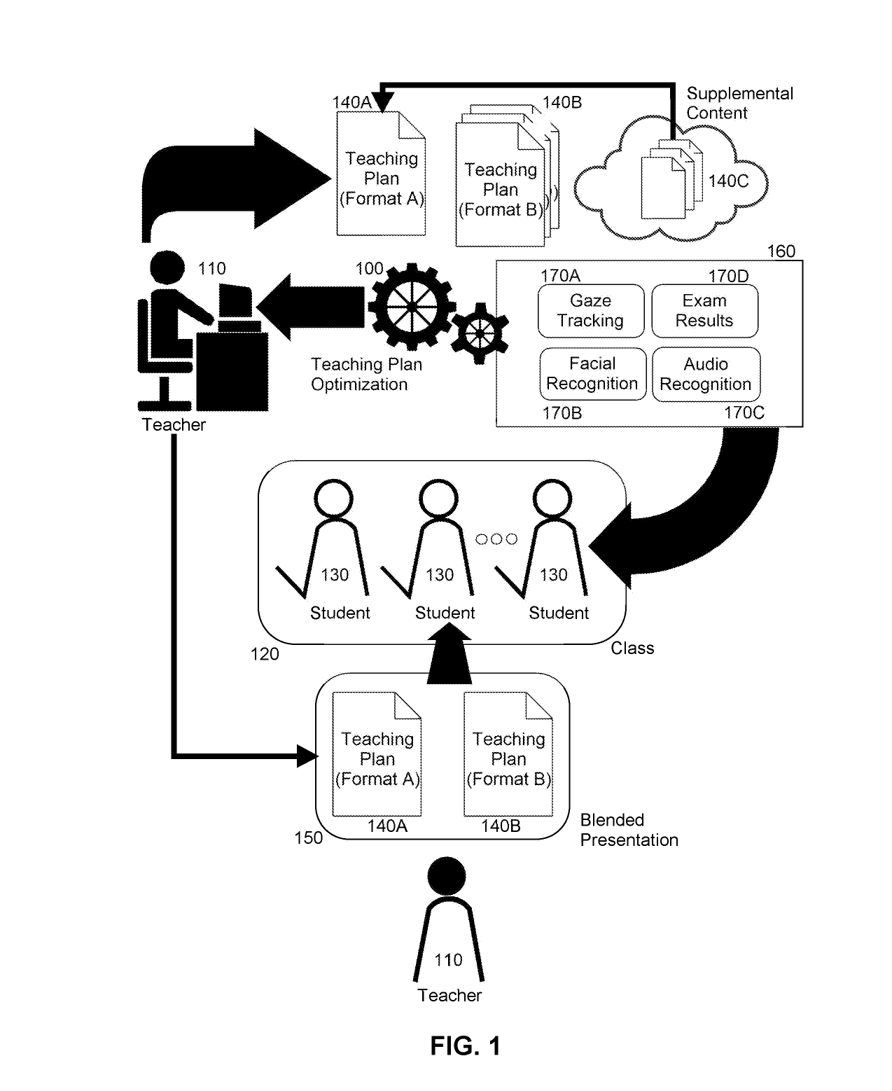

In further illustration, FIG. 1 pictorially shows a process for teaching plan optimization. As shown in FIG. 1, a teacher 110 loads a teaching plan 140A of one presentation format into memory for processing by teaching plan optimization logic 100. Teaching plan optimization logic 100 parses the content of the loaded teaching plan 140A and compares the content of the loaded teaching plan 140A to other, pre-stored teaching plans 140B of different presentation formats from the presentation format of the loaded teaching plan 140A. Thereafter, the teaching plan optimization logic 100 identifies at least one comparable one of the pre-stored teaching plans 140B and designates the comparable one or ones of the pre-stored teaching plans 140B as an alternative teaching plan to the loaded teaching plan 140A. Optionally, the teaching plan optimization logic 100 generates and transmits by way of a search engine, a search engine query based upon the content of the loaded teaching plan 140A in order to locate comparable supplemental content 140C about the global Internet for incorporation with the loaded teaching plan 140A.

Thereafter, the teacher 110 presents the loaded teaching plan 140A to a class 120 of students 130 either through live presentation, or through remote presentation utilizing distance learning. In this regard, in the latter instance, the loaded teaching plan 140A is delivered on demand over a computer communications network to different endpoint computing devices, each associated with a different one of the students 130. In the former instance, the loaded teaching plan 140A is delivered live in a classroom environment to all of the students 130. Optionally, the loaded teaching plan 140A is delivered in a hybrid manner to some of the students 130 through distance learning, and to the remaining students 130 in a live classroom setting.

In any event, teaching plan optimization logic 100 then monitors the impact of the loaded teaching plan 140A upon the students 130. For instance, gaze tracking 170A for each of the students 130 is utilized in order to identify an attention level of each corresponding one of the students 130, or to determine a duration of time in which each of the students 130 remains fixated upon a page of material, or to detect different cycles of eye fixation upon a page of material, in all cases in order to determine a degree of comprehension by the students 130 of the teaching plan 140A and to identify ones of the students 130 determined to be performing poorly below a threshold performance level in response to the teaching plan 140A. As another example, facial recognition 170B is employed utilizing video capture of each of the students 130 in order to detect different facial expressions of each of the students such as a quizzical expression or a frown indicative of the response of each of the students to the loaded teaching plan 140A, again in order to determine a degree of comprehension by the students 130 of the teaching plan 140A and to identify ones of the students 130 determined to be performing poorly below a threshold performance level in response to the teaching plan 140A.

As yet another example, audio recognition 170C is utilized to detect the tone of the voice of ones of the students 130 as the students 130 interact with the teacher 110. Indeed, the speech of the individual students 130 may be speech recognized such that the content of speech provided by the individual students 130 may be natural language analyzed or keyword matched to known keywords mapped to particular degrees of comprehension in order to determine a degree of comprehension by the students 130 of the teaching plan 140A and to identify ones of the students 130 determined to be performing poorly below a threshold performance level in response to the teaching plan 140A. Finally, examination results 170D of one or more examinations pertinent to the teaching plan 140A and presented to the students 130 are processed to identify ones of the students performing poorly in response to the teaching plan 140A.

Once the teaching plan optimization logic 100 identifies ones of the students 130 determined to have performed below a threshold level in response to the teaching plan 140A, the teaching plan optimization logic 100 computes a blended presentation 150 of both the teaching plan 140A and the comparable one of the pre-stored teaching plans 140B based upon a proportion of those of the students 130 determined to have performed poorly in response to the teaching plan 140A alone. The computation specifically indicates a duration of a fixed teaching period in which each individual one of the teaching plans 140A, 140B is presented to the students 130. The teaching plan optimization logic 100 then provides the blended presentation 150 to the teacher 110 for presentation to the students 130. Subsequently, the teaching plan optimization logic 100 determines the response by the students 130 to the blended presentation 150 as before and the blended presentation may be modified in terms of the duration of time of the fixed teaching period in which the individual ones of the teaching plans 140A, 140B are presented to the students.

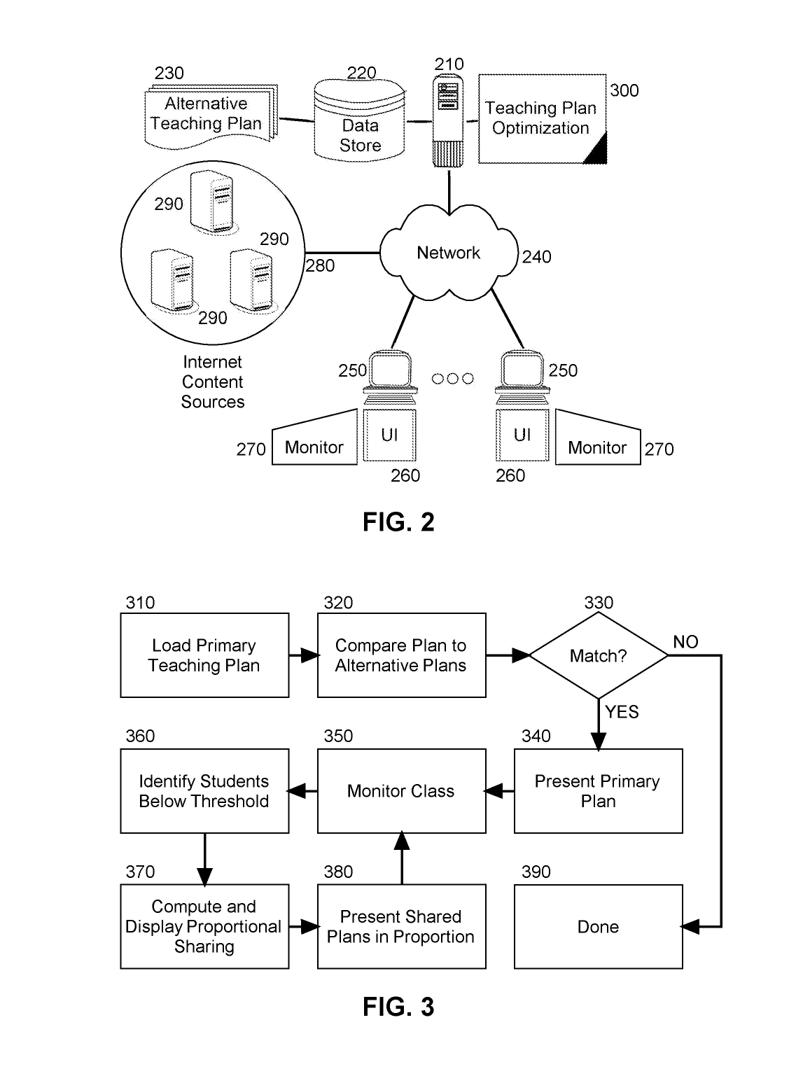

The process described in connection with FIG. 1 may be implemented in a data processing system. In further illustration, FIG. 2 schematically shows a data processing system configured for teaching plan optimization. The system includes a host computing system 210 including one or more computers, each with memory and at least one processor. A data store 220 is coupled to the host computing system 210 and stores therein different alternative teaching plans 230 of different presentation formats. The host computing system 210 is coupled over computer communications network 240 to different content sources 290 disposed about a global computer communications network 280 such as the global Internet. As well, the host computing system 210 is coupled to different end user computing clients 250.

A teaching plan optimization module 300 executes in the host computing system 210. The teaching plan optimization module 300 is accessed by different teachers through respectively different user interfaces 260 provided in corresponding ones of the computing clients 250. The teaching plan optimization module 300 includes program code that when executes in the memory of the host computing system 210, is enabled to load into memory a teaching plan of one presentation format and to locate in the data store 220, at least one comparable one of the alternative teaching plans 230. The location in the data store 220 of a comparable one of the alternative teaching plans 230 may occur by comparing a table of contents or other index structure for each of the teaching plans 230 in order to identify similar headings. Ones of the plans 230 with a threshold number of similar portions according to similar headings are then deemed sufficiently similar so as to constitute comparable ones of the teaching plans 230.

The program code of the teaching plan optimization module 300 additionally is enabled to utilize a monitor 270 such as a gaze tracker, to determine the response by each individual student in a class to the presentation of the loaded teaching plan in order to compute a proportional blend of utilization of the loaded teaching plan and the comparable one of the alternative teaching plans 230. The monitor 270 can be physically positioned proximate to each student in a live classroom setting, or implemented using the camera of an end user computing device for each student in a distance learning setting. As well, the program code of the teaching plan optimization module 300 is enabled to locate amongst the content sources 290, content that is supplemental to the loaded teaching plan for inclusion with the loaded teaching plan. So much may be performed by formulating different search queries with the headings of the loaded teaching plan and issuing the queries utilizing a search engine with results in a result set for each of the queries providing the supplement content to the loaded teaching plan.

In even yet further illustration of the operation of the teaching plan optimization module 300, FIG. 3 is a flow chart illustrating a process for teaching plan optimization. Beginning in block 310, teaching plan optimization module 300 loads a primary teaching plan into memory. In block 320, teaching plan optimization module 300 compares the content of the primary teaching plan to the content of one or more stored alternative teaching plans in order to identify a matching plan, albeit in a different presentation format. In decision block 330, if a match is not found, the process ends in block 390. Otherwise, the process continues through block 340. In block 340, teaching plan optimization module 300 presents the primary teaching plan to different students in a class. In block 350, teaching plan optimization module 300 monitors the response by the students, for instance by way of facial recognition, gaze tracking, audio recognition or the processing of examination results. In block 360, teaching plan optimization module 300 identifies one or more of the students determined to have responded to the primary teaching plan below a threshold level.

Consequently, in block 370 teaching plan optimization module 300 computes a proportional sharing of a fixed period of time based upon the proportion of students in the class determined to have responded to the primary teaching plan below the threshold level. As such, in block 380 as suggested by teaching plan optimization module 300, a teacher presents the primary teaching plan during an apportioned duration of time during the fixed period of time for presentation, while the teacher presents the matched one of the alternative plans during a remaining duration of time during the fixed period of time. Thereafter, the process repeats in iterative fashion with the response by the students to the presentation of the combination of teaching plans and the apportionment adjusted for each iteration based upon the computed number of students responding below the threshold level.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for teaching plan optimization, the method comprising:
loading a teaching plan into memory of a computer;
comparing the loaded teaching plan to a set of existing teaching plans disposed in fixed storage of the computer to identify an alternate teaching plan utilizing a presentation format that differs from a presentation format of the loaded teaching plan;
monitoring by the computer a class response to the loaded teaching plan in order to determine an effectiveness of the loaded teaching plan;
identifying a portion of the class demonstrating a determined effectiveness of the loaded plan teaching below a threshold value; and,
computing and displaying a proportional sharing of presentation of both the loaded teaching plan and the alternative teaching plan to the class based upon the identified portion of the class demonstrating the determined effectiveness of the loaded teaching plan below the threshold value.

2. The method of claim 1, wherein the monitoring is performed by facial recognition of individual students in the class.

3. The method of claim 1, wherein the monitoring is performed by gaze tracking of individual students in the class.

4. The method of claim 1, wherein the monitoring is performed by audio recognition of individual students in the class.

5. The method of claim 1, wherein the monitoring is performed separately and remotely for each student at a different endpoint computer in a distance learning arrangement.

6. The method of claim 1, further comprising:
generating a query of different terms pertinent to the loaded teaching plan;
submitting the query over a computer communications network to a search engine in order to identify supplemental teaching content;
retrieving the identified supplemental teaching content from over the computer communications network; and,
associating the retrieved supplemental teaching content with the loaded teaching plan for delivery to the class.

7. The method of claim 1, further comprising:
monitoring by the computer a class response to both teaching plans in order to determine an effectiveness of each of the teaching plans;
identifying a portion of the class demonstrating a determined effectiveness of each of the teaching plans below a threshold value; and,
re-computing and re-displaying the proportional sharing of presentation of both teaching plans to the class based upon the identified portion of the class demonstrating the determined effectiveness of each of the teaching plans below the threshold value.

8. A data processing system configured for teaching plan optimization, the system comprising:
a computer with memory and at least one processor; and,
a teaching plan optimization module executing in the memory of the computer, the module comprising program code enabled upon execution in the computer to load a teaching plan into the memory of the computer, compare the loaded teaching plan to a set of existing teaching plans disposed in fixed storage of the computer to identify an alternate teaching plan utilizing a presentation format that differs from a presentation format of the loaded teaching plan, monitor by the computer a class response to the loaded teaching plan in order to determine an effectiveness of the loaded teaching plan, identify a portion of the class demonstrating a determined effectiveness of the loaded plan teaching below a threshold value, and compute and display a proportional sharing of presentation of both the loaded teaching plan and the alternative teaching plan to the class based upon the identified portion of the class demonstrating the determined effectiveness of the loaded teaching plan below the threshold value.

9. The system of claim 8, wherein the monitoring is performed by facial recognition of individual students in the class.

10. The system of claim 8, wherein the monitoring is performed by gaze tracking of individual students in the class.

11. The system of claim 8, wherein the monitoring is performed by audio recognition of individual students in the class.

12. The system of claim 8, wherein the monitoring is performed by separately and remotely for each student at a different endpoint computer in a distance learning arrangement.

13. The system of claim 8, wherein the program code is further enabled to generate a query of different terms pertinent to the loaded teaching plan, submit the query over a computer communications network to a search engine in order to identify supplemental teaching content, retrieve the identified supplemental teaching content from over the computer communications network, and associate the retrieved supplemental teaching content with the loaded teaching plan for delivery to the class.

14. A computer program product for teaching plan optimization, the computer program product comprising a computer readable storage medium having program instructions embodied therewith, the program instructions executable by a device to cause the device to perform a method comprising:
loading a teaching plan into memory of a computer;
comparing the loaded teaching plan to a set of existing teaching plans disposed in fixed storage of the computer to identify an alternate teaching plan utilizing a presentation format that differs from a presentation format of the loaded teaching plan;
monitoring by the computer a class response to the loaded teaching plan in order to determine an effectiveness of the loaded teaching plan;
identifying a portion of the class demonstrating a determined effectiveness of the loaded plan teaching below a threshold value; and,
computing and displaying a proportional sharing of presentation of both the loaded teaching plan and the alternative teaching plan to the class based upon the identified portion of the class demonstrating the determined effectiveness of the loaded teaching plan below the threshold value.

15. The computer program product of claim 14, wherein the monitoring is performed by facial recognition of individual students in the class.

16. The computer program product of claim 14, wherein the monitoring is performed by gaze tracking of individual students in the class.

17. The computer program product of claim 14, wherein the monitoring is performed by audio recognition of individual students in the class.

18. The computer program product of claim 14, wherein the monitoring is performed by separately and remotely for each student at a different endpoint computer in a distance learning arrangement.

19. The computer program product of claim 14, wherein the method further includes:
generating a query of different terms pertinent to the loaded teaching plan;
submitting the query over a computer communications network to a search engine in order to identify supplemental teaching content;
retrieving the identified supplemental teaching content from over the computer communications network; and,
associating the retrieved supplemental teaching content with the loaded teaching plan for delivery to the class.

20. The computer program product of claim 14, wherein the method further includes:
monitoring by the computer a class response to both teaching plans in order to determine an effectiveness of each of the teaching plans;
identifying a portion of the class demonstrating a determined effectiveness of each of the teaching plans below a threshold value; and,
re-computing and re-displaying the proportional sharing of presentation of both teaching plans to the class based upon the identified portion of the class demonstrating the determined effectiveness of each of the teaching plans below the threshold value.
